(19) United States
(12) Patent Application Publication
(10) Pub. No.: US 2007/0138961 A1
(43) Pub. Date: Jun. 21, 2007

(54) CONDUCTIVE ELEMENT HAVING A CORE AND COATING AND METHOD OF MAKING

(75) Inventors: BERNARD PATRICK BEWLAY, SCHENECTADY, NY (US); BRUCE ALAN KNUDSEN, AMSTERDAM, NY (US); JAMES ANTHONY BREWER, SCOTIA, NY (US); DAVID JEFFREY BRYAN, SCHENECTADY, NY (US); VORAMON SUPATARAWANIC H DHEERADHADA, LATHAM, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/609,151

(22) Filed: Dec. 11, 2006

Related U.S. Application Data
(63) Continuation of application No. 10/899,097, filed on Jul. 27, 2004.

(51) Int. Cl. B32B 15/00; H01J 61/36; H01J 17/18

(52) U.S. Cl. 313/623; 428/607; 428/663; 428/670; 313/624

(57) ABSTRACT

A conductive element including a core and a coating, wherein the core comprises a material selected from the group consisting of molybdenum, molybdenum alloys, rhenium, rhenium alloys, molybdenum-rhenium alloys, and combinations thereof, and wherein the coating comprises at least one material selected from the group consisting of aluminum, an aluminum alloy, silicon, a silicon alloy, chromium, a chromium alloy, and combinations of two or more thereof.

### CROSS REFERENCE TO RELATED APPLICATIONS

This application is a continuation-in-part of U.S. patent application Ser. No. 10/899097, entitled “A STRUCTURE HAVING ELECTRODES WITH METAL CORE AND COATING”, filed Jul. 27, 2004, which is herein incorporated by reference.

### BACKGROUND

Embodiments of the invention relate to a conductive element and a method of making the conductive element.

Usually, discharge lamps consist of an outer envelope made of ceramic that encompasses an inner enclosure known as a sealed envelope or “arc tube”. The sealed envelope is usually made of quartz, yttrium aluminum garnet, ytterbium aluminum garnet, micro grain polycrystalline alumina, polycrystalline alumina, sapphire, and yttria. The alumina or yttria based sealed envelope typically employs pure niobium or a niobium alloy as a conductive feedthrough material since niobium has a coefficient of thermal expansion compatible to that of yttria and alumina based ceramics. However, at high temperatures niobium has a very poor chemical resistance to oxygen and nitrogen, and the resistance substantially decreases as the temperature increases. As a result, the sealed envelope cannot be operated in air and has to be operated in a protective environment, such as by maintaining a vacuum or providing an inert gas in the space available between the outer envelope and the sealed envelope. Unfortunately, the use of the outer envelope decreases the optical efficiency of the lamp. Further, the use of the outer envelope results in the size of the lamp being larger, and also adds to the cost of the lamp.

### BRIEF DESCRIPTION

In one embodiment a conductive element is provided. The conductive element comprises a core and a coating, wherein the core comprises a material selected from the group consisting of molybdenum, molybdenum alloys, rhenium, rhenium alloys, molybdenum-rhenium alloys, and combinations thereof, and wherein the coating comprises at least one material selected from the group consisting of aluminum, an aluminum alloy, silicon, a silicon alloy, chromium, a chromium alloy, and combinations of two or more thereof.

In another embodiment, a structure is provided including a sealed envelope that is transparent or translucent, at least two electrode tips disposed within the sealed envelope, and at least two conductive feedthroughs coupled to the electrode tips. In one embodiment, the conductive feedthroughs comprise a core and a coating, wherein the core comprises a material selected from the group consisting of molybdenum, molybdenum alloys, rhenium, rhenium alloys, molybdenum-rhenium alloys, and combinations of two or more thereof, and the coating comprises at least one layer of aluminum, an aluminum alloy, an aluminide, silicon, a silicon alloy, a silicide, chromium, a chromide, and combinations of two or more thereof.

In yet another embodiment, a method of making a conductive feedthrough for a lamp is provided. The method includes providing a molybdenum-rhenium alloy core, providing at least one precursor of a coating material in a slurry, depositing the slurry on the molybdenum-rhenium alloy core such that the molybdenum-rhenium alloy core is covered by the slurry, and heating the molybdenum-rhenium alloy core covered by the slurry at a determined temperature in an inert atmosphere for a determined period of time to form a coating on the molybdenum-rhenium alloy core.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic overview of an exemplary sealed envelope;

FIG. 2 is a schematic illustration of a conductive element having a single layer of coating;

FIG. 3 is a schematic illustration of a conductive element having more than one layer of coating;

FIGS. 4-7 are schematic illustrations of conductive feedthroughs including coil overwraps and coatings in accordance with various embodiments;

FIG. 8 illustrates a specific embodiment discharge lamp including a conductive element in accordance with a specific embodiment of the invention;

FIG. 9 is a plot comparing weight change between a silicide coated conductive element having a molybdenum-rhenium core and an uncoated conductive element having a molybdenum-rhenium core at a temperature of 600° C.; and

FIG. 10 is a plot comparing the weight change between a silicide coated conductive element having a molybdenum-rhenium wire at temperatures of 600° C. and 750° C. for 200 hours.

### DETAILED DESCRIPTION

As discussed in detail below, embodiments of the present invention include a conductive element comprising a core and a coating. In one embodiment, the conductive element comprises a metal core and a coating wherein the term ‘metal’ is intended to broadly refer to a material that is electrically conductive at low temperatures. Further, a metal may include alloys or disparates and may have one or two additional phases including inter-metallics and carbides. In accordance with one or more embodiments described herein, the core of the conductive element may include molybdenum or a molybdenum alloy, rhenium or a rhenium alloy or combinations thereof. In one embodiment, the core of the conductive element may include a molybdenum-rhenium alloy. Furthermore, in accordance with one or more embodiments described herein, the coating of the conductive element may comprise at least one material wherein the material may include aluminum or an aluminum alloy such as an aluminide, silicon or a silicon alloy such as a silicide, chromium or a chromium alloy such as a chromide, or combinations of two or more such materials. In one embodiment, the coating may include one or more layers on the conductive element core.

In one embodiment, the conductive element is employed in a discharge lamp. As described herein, the conductive element of the present invention employed in the lamp may also be referred to as a conductive feedthrough. In one embodiment, the lamp may be a high intensity discharge (HID) lamp. In another embodiment, the lamp may be a ceramic metal halide (CMH) lamp. In yet another embodiment, the lamp may be a high-pressure sodium (HPS) lamp. In yet another embodiment, the lamp may be an automotive lamp.

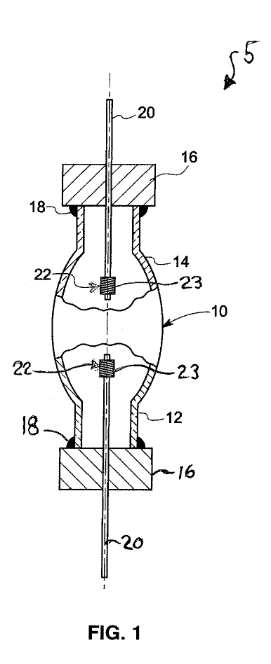

FIG. 1 is a schematic diagram of an exemplary discharge lamp 5 including embodiments of the present invention. The discharge lamp 5, may include a sealed envelope 10 that may be transparent or translucent. The sealed envelope 10 may be made of a ceramic material, such as, but not limited to, quartz, polycrystalline alumina, micro grain polycrystalline alumina, yttrium aluminum garnet, ytterbium aluminum garnet, sapphire, and yttria. The sealed envelope 10 may be sealed at the lower end 12 and the upper end 14 by two end caps 16. In the illustrated sealed envelope, the end caps 16 are bonded to the sealed envelope 10 by means of a sealing composition 18. The discharge lamp 5 further includes a conductive feedthrough 20 extending out of each end cap 16. Both of the conductive feedthroughs 20 extend through the end caps 16 and terminate at the electrode tip 22. As depicted in the illustrated embodiment, the electrode tips 22 may include an overwrap, such as overwrap 23. As will be appreciated, such electrode tip overwraps 23 may act as heat sinks to absorb the heat from the electrode tips 22 and dissipate the heat into the surroundings. In some embodiments, the electrode tips 22 and/or the overwraps 23 may include rhenium or rhenium alloys, molybdenum or molybdenum alloys, tantalum or tantalum alloys, tungsten or tungsten alloys, or combinations of two or more thereof. In one embodiment, the overwraps 23 may include a molybdenum rhenium alloy.

The discharge lamp 5 further comprises an optically active dosing substance disposed within the sealed envelope 10. The dosing substance also known as a “fill material” emits a desired spectral energy distribution in response to being excited by an electrical discharge across the electrodes. The dosing substance may comprise a luminous gas, such as rare gas and mercury. The dosing substance may also include a halide (e.g., bromine, iodine, etc.), a rare earth metal halide, and so forth.

Typically, the operating temperature of the sealed envelope 10 varies from about 500° C. to about 1500° C. At such high temperatures, the conductive feedthrough 20 can heat up to temperatures of about 200° C. and higher. At such temperatures, conventional conductive elements are typically susceptible to chemical reactions with oxygen and nitrogen. Such chemical reaction of conventional conductive feedthroughs with oxygen, or oxidation of the conductive feedthroughs typically results in increased resistivity of the conductive feedthroughs. This in turn leads to a decrease in the amount of current supplied to the electrode, and can negatively affect the performance of the lamp. Moreover, conventional conductive feedthroughs tend to expand as a result of oxidation that can lead to cracking of the sealed envelope. Similarly undesirable chemical reaction of conventional conductive feedthrough with nitrogen can lead to nitride formation on the surface of the conductive feedthrough, which tends to make the feedthrough brittle. Additionally, nitrogen can seep from the surface of conventional conductive feedthroughs into their center resulting in nitride formation inside the conductive feedthrough, further making the conductive feedthrough brittle. To avoid such deleterious reactions with conventional conductive feedthroughs, an outer envelope made of quartz is typically employed to cover the sealed envelope 10 to provide a protective environment, such as vacuum or inert gas, which prevents the degradation of the conductive feedthrough due to oxide or nitride formation. However, as previously mentioned, the use of the outer envelope may result in an increase in the size of the lamp and, also adds to the cost of lamp.

In accordance with one aspect of the present invention, the conductive feedthrough 20 comprises a conductive element core and a coating, wherein the coating acts to prevent deleterious chemical reactions between the conductive element core and materials, such as but not limited to oxygen and nitrogen, without the need for an outer envelope. In one embodiment, the core of the conductive feedthrough 20 may be a metal and may include molybdenum or a molybdenum alloy, rhenium or a rhenium alloy or combinations thereof. In one specific embodiment, the core of the conductive element may include a molybdenum-rhenium alloy. Furthermore, in one embodiment, the coating of the conductive element may include aluminum or an aluminum alloy such as an aluminide, silicon or a silicon alloy such as a silicide, chromium or a chromium alloy such as a chromide, or combinations of two or more such materials.

In one embodiment, the coating may comprise one or more layers or regions on the conductive element core. In one embodiment, the coating advantageously protects the core of the conductive feedthrough 20 from chemically reacting with oxygen, and nitrogen in air at temperatures varying in a range from about 200° C. to about 1100° C. This facilitates use of the sealed envelope directly in the ambient atmosphere without requiring an additional outer envelope around sealed envelope 10.

As will be described with respect to FIGS. 4-8, the conductive feedthroughs may further a coil overwrap wrapped around the circumference and along the length of the conductive element. In one embodiment, the coil overwrap may provide compliance to the conductive element, and this can help to reduce the thermal stress on thermal cycling. The coil overwraps may be provided directly on the conductive element core or over one or more layers of coating on the core. Moreover, the coil overwraps may themselves be coated in the presence or absence of other conductive element coatings. In one embodiment, a coil overwrap may be coated and then wrapped around the conductive element. Alternatively, the coil overwrap may be coiled around the conductive element and then the combined assembly may be coated. In one embodiment, the coil overwrap may include a molybdenum-rhenium alloy. In one embodiment, the coil overwrap may be coated with a material including aluminum or an aluminum alloy such as an aluminide, silicon or a silicon alloy such as a silicide, chromium or a chromium alloy such as a chromide, or combinations of two or more such materials.

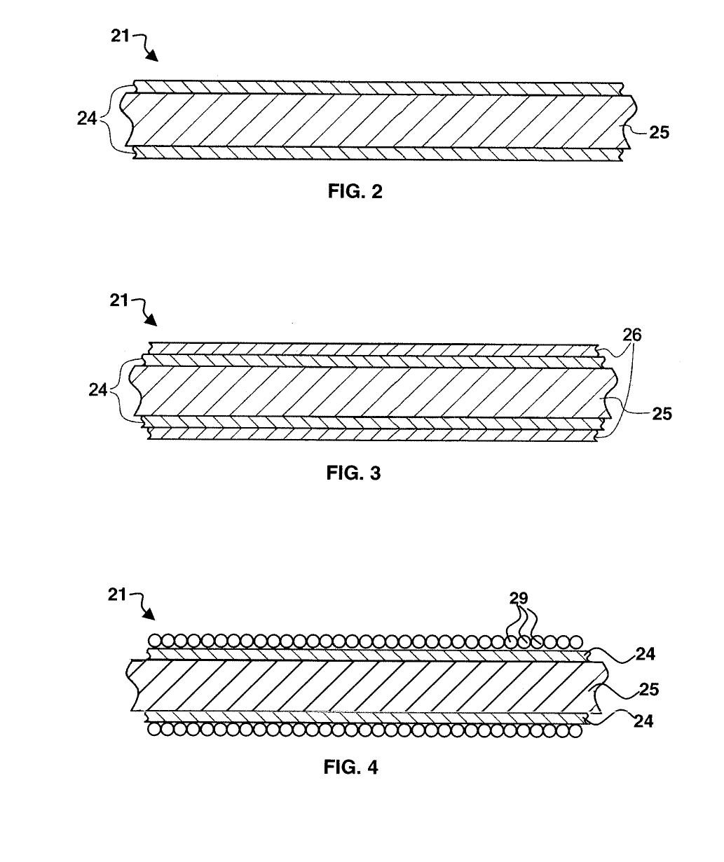

FIG. 2 is a schematic illustration of a conductive element 21 comprising a first layer of coating 24 on a conductive element core 25. Similarly, FIG. 3 is a schematic illustration of the conductive element 21 having more than one layer of coating on the conductive element core 25. In the illustrated embodiment of FIG. 3, the conductive element 21 includes a first layer of coating 24 and a second layer of coating 26 on the conductive element core 25. In one embodiment, the thickness for each layer of coating may range from about 5 micrometers to about 500 micrometers. In one embodiment, the thickness of the coating(s) may range from about 10 micrometers to about 300 micrometers. In another specific embodiment, the thickness of the coating(s) may range from about 25 micrometers to about 150 micrometers. In one embodiment, the first layer of coating 24 and the second layer of coating 26 may comprise the same material. However, in another embodiment, the first layer of coating 24 and the second layer of coating 26 may be formed from different materials.

In one embodiment, the coating may comprise aluminides of metals, such as, chromium, titanium, germanium, molybdenum, niobium, zirconium, hafnium, iron, tin, or yttrium, as well as combinations of two or more thereof, and alloys thereof. In one embodiment, the aluminide comprises a titanium aluminide. In another specific embodiment, the aluminide may comprise a molybdenum aluminide. In yet another embodiment, the aluminide may comprise a molybdenum-rhenium aluminide.

In another embodiment, the coating may comprise silicides, such as, chromium, titanium, germanium, molybdenum, niobium, iron, hafnium, zirconium, tin, or rare earth metals such as yttrium, as well as combinations thereof, and alloys thereof. In one embodiment, the silicide comprises a niobium-chromium-iron silicide. In another embodiment, the silicide comprises a niobium-chromium-titanium-iron silicide. In a further embodiment the silicide may comprise a molybdenum-rhenium silicide.

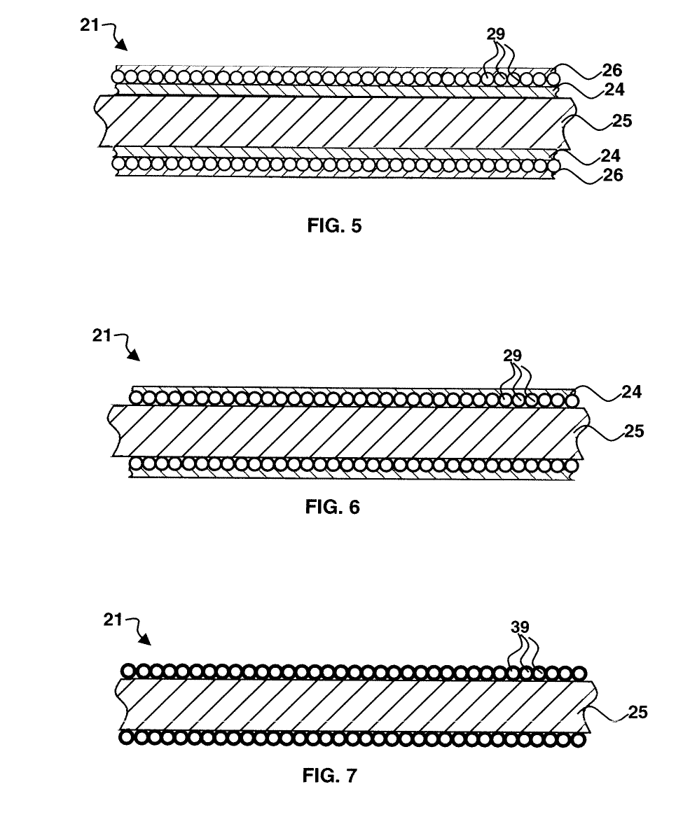

FIGS. 4-7 are schematic illustrations of conductive feedthroughs including coil overwraps and coatings in accordance with various embodiments. More specifically, FIG. 4 illustrates a conductive element 21 having a core 25 and a first layer of coating 24 and a coil overwrap 29 around the first layer of coating 24. Although not shown, the coil overwrap 29 may similarly be formed around more than one layer of coating. FIG. 5 illustrates a conductive element 21 having a core 25 and a first layer of coating 24, a coil overwrap 29 around the first layer of coating 24, as well as a second layer of coating 26 coated over the coil overwrap 29. FIG. 6 illustrates a conductive element 21 having a core 25, a coil overwrap 29 wrapped directly around the core 25, and a first layer of coating 24 coated over the coil overwrap 29. FIG. 7 illustrates a conductive element 21 having a core 25 and a coated coil overwrap 39 wrapped around the core 25. The coil overwrap 39 of FIG. 7 may be coated with the same materials used for the first or second layers of coating 24, 26. Although a variety of core, coating and coil configurations for the conductive element have been illustrated, it is contemplated that other such configurations not illustrated are within the spirit and scope of the invention embodiments.

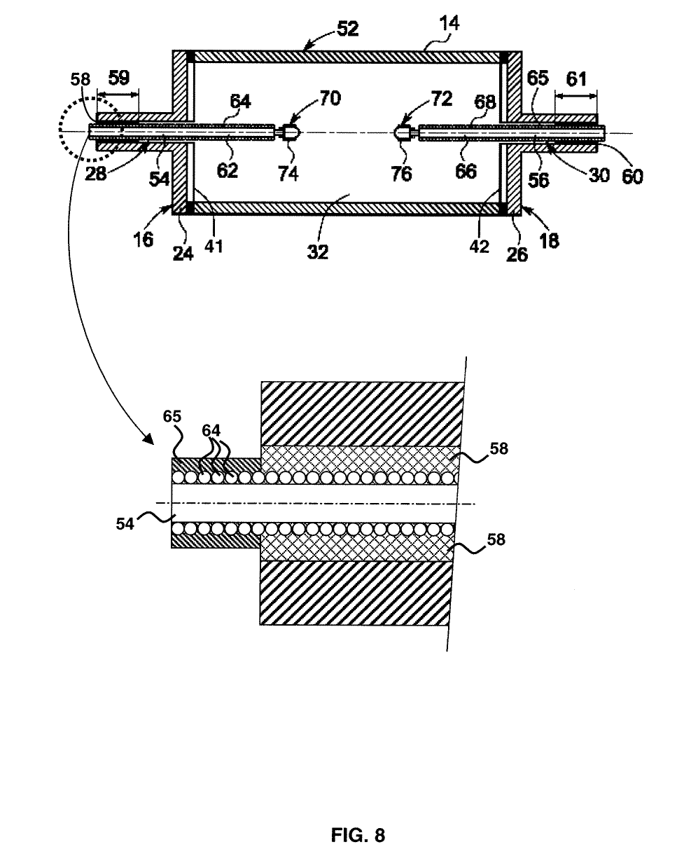

FIG. 8 illustrates a specific embodiment of a discharge lamp including a conductive element in accordance with an alternative embodiment of the invention. In the alternative embodiment shown in FIG. 8, the lamp 50 employs an alternative conductive element disposed in an arc envelope assembly 52 having a ceramic arc envelope 14 and the end structures 16 and 18 coupled to the opposite ends 41 and 42 of the ceramic arc envelope 14. As illustrated, the end structures 16 and 18 include structures 24 and 26 having openings extending into protruding passageways 28 and 30 communicative with an interior chamber 32. Further, the arc envelope assembly 52 includes conductive elements 54 and 56 extending through and sealed with the passageways 28 and 30 by using seal glasses 58 and 60.

In the illustrated embodiment, the conductive element 54 includes a core, such as a mandrel 62 having a coil overwrap 64 wrapped around the circumference and along the length of the mandrel 62. Similarly, the conductive element 56 disposed opposite to the conductive element 54 includes a core, such as a mandrel 66 having a coil overwrap 68 wrapped around the circumference and along the length of the mandrel 66. As will be appreciated, the dimensions of the mandrels 62 and 66 and overwraps 64 and 68 may be correspondingly adjusted to the dimensions of the passageways 28 and 30. For example, in some embodiments, the diameter of the mandrels 62 and 66 may be about 0.40 mm and the diameter of the overwraps 64 and/or 68 may be about 0.125 mm. Similarly, for lamps with passageways 28 and 30 having relatively larger diameter, the diameter of the mandrels 62 and 66 may be about 0.50 mm and the diameter of the overwraps 64 and/or 68 may be about 0.175 mm. Likewise, for lamps with even larger diameter of passageways 28 and 30, the diameter of the mandrels 62 and 66 may be about 0.90 mm and the diameter of the overwraps 64 and/or 68 may be about 0.3 mm. However, other dimensions are within the scope of the disclosed embodiments.

Further, in some embodiments, the mandrels 62 and 66 are formed from a first molybdenum-rhenium alloy and the coil overwraps 64 and 68 are formed from a second molybdenum-rhenium alloy, which may be the same as or different from the first molybdenum-rhenium alloy of the mandrel. Accordingly, in some embodiments, the molybdenum-rhenium alloy may include about 35 weight percent to about 55 weight percent of rhenium. Further, the overwraps 64 and 68 may be made of molybdenum, or a molybdenum alloy, or a second molybdenum-rhenium alloy, or tungsten, or combinations thereof. In some embodiments, the mandrel and the overwrap may be made of substantially similar molybdenum-rhenium alloys. As will be appreciated, the overwraps 64 and 68 facilitate distribution of stress experienced by the mandrels 62 and 66 at points where the seal glasses 58 and 60 are in contact with the conductive elements 54 and 56, thereby substantially reducing the likelihood of any cracks or structural defects in the mandrel caused by the stress. Further, the seal glasses 58 and 60 may have lengths 59 and 61, which may vary depending on the composition of the mandrel or coil overwrap. Further, as illustrated, the ends of the two conductive elements 54 and 56 disposed inside the interior chamber 32 are coupled to the electrode tips 70 and 72. As described above with reference to FIG. 1, the electrode tips 70 and 72 may further include overwraps 74 and 76, disposed around the electrode tips.

In accordance with one embodiment, the mandrels 62 and 66 and corresponding overwraps 64 and 68 may be coated with a material including aluminum or an aluminum alloy such as an aluminide, silicon or a silicon alloy such as a silicide, chromium or a chromium alloy such as a chromide, or combinations of two or more such materials. By coating the mandrels 62 and 66 and coil overwraps 64 and 68, a non-reactive conductive element that is compliant to the thermal stresses of a discharge lamp may be obtained.

In one aspect of the present invention, a method of making a conductive element is provided. As mentioned above, in accordance with one embodiment, the conductive element may comprise a metal core and a coating. The metal core may comprise niobium, tungsten, molybdenum, or rhenium, as well as combinations of two or more thereof, and alloys thereof. In one embodiment, the metal core may comprise a molybdenum-rhenium alloy. In one embodiment, the coating may comprise at least one layer of aluminum or an aluminum alloy such as an aluminide, silicon or a silicon alloy such as a silicide, chromium or a chromium alloy such as a chromide, or combinations of two or more such materials. The material employed to make the coating may comprise at least one of aluminum, silicon, chromium, titanium, germanium, niobium, iron, tin, yttrium, and combinations thereof, and alloys thereof.

In one embodiment, the metal core may be coated using methods such as, but not limited to, chemical vapor deposition, physical vapor deposition, slurry coating, spray coating, and pack cementation, or combinations of such methods. The coated metal core is subjected to heating in an inert atmosphere to form the conductive element comprising a metal core and a coating comprising at least one layer of aluminum or an aluminum alloy such as an aluminide, silicon or a silicon alloy such as a silicide, chromium or a chromium alloy such as a chromide, or combinations of two or more such materials.

In one embodiment, a method is provided for making a conductive feedthrough 20 for a lamp, wherein the conductive feedthrough 20 comprises a molybdenum-rhenium alloy core. The method used for coating the molybdenum-rhenium core may comprise a slurry coating method. The precursor of the coating may comprise elemental powders of the precursors or alloy powders of the precursors. In one embodiment, the precursor of the coating may comprise elemental powders of aluminum, niobium, silicon, titanium, iron, germanium, yttrium, and chromium, or a combination of two or more thereof. In another embodiment, the precursor of the coating comprises at least one alloy precursor, wherein the alloy precursor comprises powders such as, aluminum, chromium, silicon, titanium, germanium, niobium, iron, tin, and yttrium, as well as combinations thereof, and alloys thereof. The precursor of the coating material may be mixed with a suitable medium to form a slurry. The medium may comprise acid, alcohol, and water or combinations thereof. In one embodiment, the medium may comprise chromic acid. In another specific embodiment, the medium may comprise phosphoric acid. In yet another embodiment, the medium may comprise water. The precursor of the coating and the medium are mixed in various proportions. In one embodiment, the proportion of water, and the precursor of the coating are 1:1.

In one embodiment, the slurry comprises 30 atomic percent molybdenum, 40 atomic percent aluminum, and 30 atomic percent chromium mixed in a solution having 2.5 weight percent of chromic acid, 15 weight percent of phosphoric acid, and balance water. In another embodiment, the slurry comprises 20 atomic percent molybdenum, 40 atomic percent aluminum, 20 atomic percent silicon, and 20 atomic percent chromium mixed in a solution having 2.5 weight percent of chromic acid, 15 weight percent of phosphoric acid, and balance water. In yet another embodiment, the slurry comprises 20 atomic percent molybdenum, 40 atomic percent aluminum, 10 atomic percent silicon, 10 atomic percent germanium, and 20 atomic percent chromium mixed in a solution having 2.5 weight percent of chromic acid, 15 weight percent of phosphoric acid, and balance water. In still another embodiment, the slurry comprises 10 atomic percent molybdenum, 10 atomic percent titanium, 40 atomic percent aluminum, 10 atomic percent silicon, 10 atomic percent germanium, and 20 atomic percent chromium mixed in a solution having 2.5 weight percent of chromic acid, 15 weight percent of phosphoric acid, and balance water. In yet another embodiment, the slurry comprises 8 atomic percent titanium, 38 atomic percent aluminum, 10 atomic percent silicon, 8 atomic percent germanium, 20 atomic percent chromium, 4 atomic percent iron, 2 atomic percent tin, and 0.2 atomic percent yttrium, and balance molybdenum mixed in a solution having 2.5 weight percent of chromic acid, 15 weight percent of phosphoric acid, and balance water. In a further embodiment, the slurry comprises 8 atomic percent titanium, 38 atomic percent aluminum, 10 atomic percent silicon, 8 atomic percent germanium, 20 atomic percent chromium, 4 atomic percent iron, 1.8 atomic percent tin, and 0.2 atomic percent yttrium, and balance molybdenum mixed in a solution having 2.5 weight percent of chromic acid, 15 weight percent of phosphoric acid, and balance water.

The molybdenum-rhenium alloy core may be immersed in the slurry for a determined period of time to deposit the slurry on the molybdenum-rhenium alloy core. In one embodiment, the period of time is in a range from about 30 seconds to about 2 hours. In another embodiment, the period of time is in a range from about 30 seconds to about 30 minutes.

In one embodiment, a binder, such as magnesium oxide, may be added to the slurry. On heating the molybdenum-rhenium alloy core coated with the slurry, the binder forms a matrix and thereby, facilitates bonding of the coating to the molybdenum-rhenium alloy core.

In one embodiment, the molybdenum-rhenium alloy coated with slurry is subjected to curing for a definite time period to remove water. In one embodiment, the molybdenum-rhenium alloy core is subjected to curing at temperatures in a range from about 25° C. to about 500° C. for a time varying in a range from about 30 minutes to about 5 hours in air. In one embodiment, the molybdenum-rhenium alloy core is subjected to curing for about 1 hour at temperatures in a range from about 25° C. to about 200° C. in air. In one embodiment, the curing of the molybdenum-rhenium core is done in a convective oven.

The molybdenum-rhenium alloy core covered with slurry may be heated in an inert atmosphere or vacuum at a temperature for a period of time. In one embodiment, prior to heating, the molybdenum-rhenium alloy core is subjected to curing. Following curing, the molybdenum-rhenium alloy core is heated further in an inert atmosphere at a different temperature for a period of time. In one embodiment, the heating is done by means such as, but not limited to a vacuum heating furnace. In another embodiment, the molybdenum-rhenium alloy core coated with slurry is subjected to a temperature in a range from about 100° C. to about 1500° C. The molybdenum-rhenium alloy core may be heated for a period of time in a range from about 30 minutes to about 5 hours. In another embodiment, the molybdenum-rhenium alloy core may be heated for a period of time to induce a beneficial reaction between the coating and core. In one embodiment the alloy core may be heated for a period of time in a range from about 1 hour to about 3 hours.

In the event the molybdenum-rhenium alloy core covered with slurry is heated in an inert atmosphere, the inert atmosphere may comprise argon, helium, neon, krypton, xenon, and combinations thereof. In one embodiment, the molybdenum-rhenium alloy core is cooled to room temperature under the same atmosphere.

In one embodiment, the conductive element described herein may be included within articles of manufacture including but not limited to electrical devices such as, lamps, electric motors, sensors, and thermocouples.

The following example illustrates certain features of the conductive element described herein, and is not intended to be limiting in any way.

### EXAMPLE 1

A coating comprising 30 atomic percent molybdenum, 40 atomic percent aluminum, 30 atomic percent chromium is prepared. A 100 grams mixture of the precursor of the coating is prepared by taking elemental powders of molybdenum, aluminum, and chromium. A 51.4 grams charge of molybdenum powder with an average particle size of less than 20 micrometers (which may be obtained from General Electric, Fairfield, Conn.), 19.9 grams aluminum powder with a particle size ranging between 5 to 15 micrometers (which may be obtained from Alfa Aesar, Parkridge Road, Ward Hill, Mass.), and 28.7 grams chromium powder with an average particle size of less than 5 micrometers (which also may be obtained from Alfa Aesar) are mixed in a pestle and mortar. Water and ethanol are used as a medium. The mixture is then made into a slurry by subjecting to milling in a tumbling mill.

A molybdenum-rhenium alloy core (which may be obtained from Rhenium Alloys, Inc. of Elyria, Ohio) is dipped in the slurry for about 10 minutes. The molybdenum-rhenium core coated with the slurry is then cured at a temperature of about 150° C. for a period of about 2 hours in a convective oven. The molybdenum-rhenium alloy core coated with the slurry is then heated in a furnace at a temperature of about 1000° C. for 2 hours in an inert atmosphere of argon to form the coating comprising a layer of molybdenum-rhenium-chromium aluminide. The molybdenum-rhenium alloy core with the coating is then cooled to ambient temperature under the same atmosphere to obtain a conductive feedthrough 20.

### EXAMPLE 2

A coating comprising 14.2 atomic percent titanium, 13.1 atomic percent chromium, 72.7 atomic percent silicon is prepared. A 50 grams mixture of the precursor of the coating is prepared by taking elemental powders of titanium, chromium, and silicon. A 10 grams charge of titanium powder with an average particle size of about 25 micrometers (obtained from Alfa Aesar), 10 grams chromium powder with an average particle size less than 10 micrometers (obtained from Alfa Aesar), and 30 grams silicon powder with an average particle size ranging from about 1 micrometer to about 20 micrometers (obtained from Alfa Aesar) are mixed in a pestle and mortar. Water and ethanol is used as a medium. The mixture is then made into a slurry by subjecting to milling in a tumbling mill.

A molybdenum-rhenium alloy core is dipped in the slurry for about 10 minutes. The molybdenum-rhenium alloy core coated with the slurry is then heated at a temperature of about 1400° C. for a period of about 2 hours in an inert atmosphere of argon. As a result of heating, the metal powders melt and react with the molybdenum-rhenium core to form a coating comprising a layer of titanium-chromium-molybdenum-rhenium silicide. The molybdenum-rhenium core with the coating is then cooled to ambient temperature to obtain a conductive feedthrough 20.

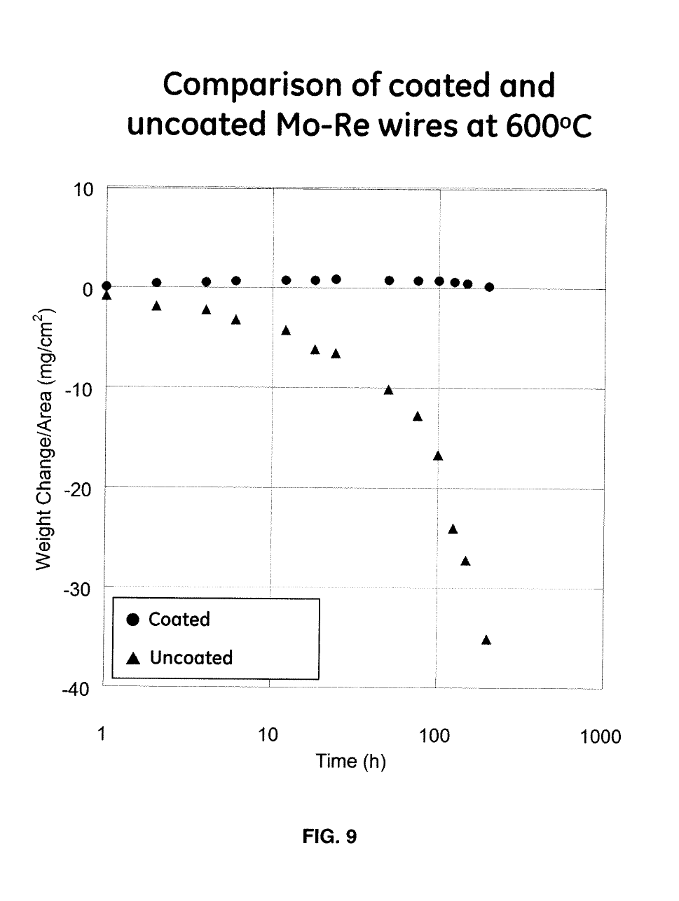

FIG. 9 is a plot comparing weight change between a silicide coated conductive element having a molybdenum-rhenium core and an uncoated conductive element having a molybdenum-rhenium core at a temperature of 600° C. As illustrated in FIG. 9, the average weight change of a silicide coated molybdenum-rhenium wire after 200 hours at 600° C. is shown to be +0.14 mg/cm² without spallation. In contrast, the average weight change of a non-coated molybdenum-rhenium wire after 200 hours at 600° C. is shown to be −35.0 mg/cm², which is nearly 250 times the weight change of the coated wire.

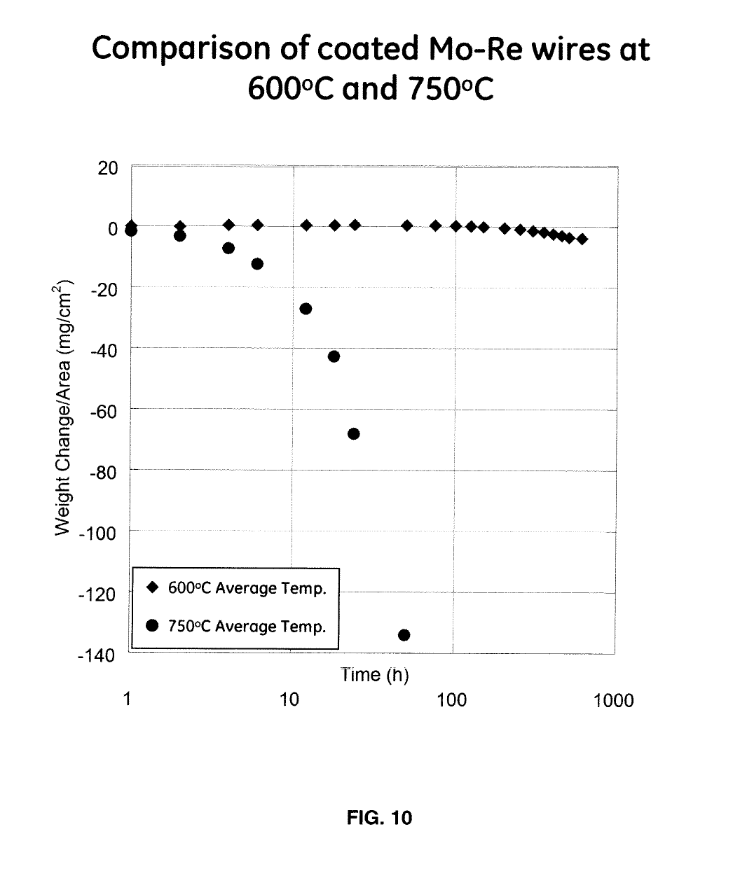

FIG. 10 is a plot comparing the weight change between a silicide coated conductive element having a molybdenum-rhenium wire at temperatures of 600° C. and 750° C. for 200 hours. With reference to the plot of FIG. 10, it can be seen that the weight loss experienced by the silicide coated molybdenum-rhenium wire at 750° C. increased with time, whereas the weight change experienced by the silicide coated molybdenum-rhenium wire at 600° C. remained negligible and only slightly decreased at times approaching 600 hours. Thus, in accordance with one embodiment as illustrated at least in part by the data of FIGS. 5 and 6, a conductive element having a molybdenum-rhenium core and a silicide coating showed material weight change of less than 10 mg/cm².

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. A conductive element comprising a core and a coating, wherein the core comprises a material selected from the group consisting of molybdenum, molybdenum alloys, rhenium, rhenium alloys, molybdenum-rhenium alloys, and combinations thereof, and wherein the coating comprises at least one material selected from the group consisting of aluminum, an aluminum alloy, silicon, a silicon alloy, chromium, a chromium alloy, and combinations of two or more thereof.

2. The conductive element according to claim 1, further comprising an aluminide.

3. The conductive element according to claim 1, further comprising a silicide.

4. The conductive element according to claim 3, wherein the silicide comprises molybdenum-chromium-iron silicide.

5. The conductive element according to claim 3, wherein the silicide comprises molybdenum-rhenium-chromium-iron silicide.

6. The conductive element according to claim 3, wherein the silicide comprises molybdenum-rhenium-chromium-iron-titanium silicide.

7. The conductive element according to claim 1, further comprising a chromide.

8. The conductive element according to claim 1, wherein the coating comprises a thickness ranging from about 5 micrometers to about 500 micrometers.

9. The conductive element according to claim 8, wherein the coating comprises a thickness ranging from about 10 micrometers to about 300 micrometers.

10. The conductive element according to claim 9, wherein the coating comprises a thickness ranging from about 25 micrometers to about 150 micrometers.

11. A structure comprising:
a sealed envelope that is transparent or translucent;
at least two electrode tips disposed within the sealed envelope; and
at least two conductive feedthroughs, each of which is coupled to one of the electrode tips, wherein the conductive feedthroughs comprise a core and a coating, wherein the core comprises a material selected from the group consisting of molybdenum, molybdenum alloys, rhenium, rhenium alloys, molybdenum-rhenium alloys, and combinations of two or more thereof, and wherein the coating comprises at least one layer of aluminum, an aluminum alloy, an aluminide, silicon, a silicon alloy, a silicide, chromium, a chromide, and combinations of two or more thereof.

12. The structure according to claim 11, wherein the sealed envelope comprises a material selected from the group consisting of quartz, polycrystalline alumina, micro grain polycrystalline alumina, yttria, yttrium aluminum garnet, and ytterbium aluminum garnet.

13. The structure according to claim 11, wherein the at least two electrode tips comprises tungsten.

14. The structure according to claim 11, wherein the at least two electrode tips comprises rhenium.

15. The structure according to claim 11, wherein the at least two electrode tips comprises molybdenum.

16. The structure according to claim 11, wherein the metal core comprises a material selected from the group consisting of tungsten, molybdenum, rhenium, combinations thereof, and alloys thereof.

17. The structure according to claim 16, wherein the metal core comprises a molybdenum-rhenium alloy.

18. The structure according to claim 11, wherein the aluminide comprises an aluminide of at least one of chromium, titanium, niobium, zirconium, hafnium, iron, tin, yttrium, combinations thereof, and alloys thereof.

19. The structure according to claim 18, wherein the aluminide is a titanium aluminide.

20. The structure according to claim 18, wherein the aluminide is a molybdenum aluminide.

21. The structure according to claim 11, wherein the silicide comprises a silicide of at least one material selected from the group consisting of aluminum, chromium, titanium, germanium, niobium, iron, hafnium, zirconium, and combinations of two or more thereof, and alloys thereof.

22. The structure according to claim 21, wherein the silicide comprises molybdenum-chromium-iron silicide.

23. The structure according to claim 21, wherein the silicide comprises molybdenum-rhenium-chromium-iron silicide.

24. The structure according to claim 21, wherein the silicide comprises molybdenum-rhenium-chromium-iron-titanium silicide.

25. The structure according to claim 11, wherein the structure is a high intensity discharge lamp.

26. The structure according to claim 11, wherein the structure is a ceramic metal halide lamp.

27. The structure according to claim 11, wherein the structure is a high-pressure sodium lamp.

28. The structure according to claim 11, wherein the structure is an automotive lamp.

29. The structure according to claim 11, wherein the sealed envelope and the conductive feedthrough are operated in air.

30. The structure according to claim 11, further comprising an overwrap around the core.

31. The structure according to claim 30, wherein the coating is coated over the overwrap.

32. The structure according to claim 31, wherein the core comprises a molybdenum or a molybdenum alloy, the overwrap comprises molybdenum or a molybdenum alloy, and the coating comprises a silicide.

33. A method of making a conductive feedthrough for a lamp, the method comprising:
providing a molybdenum-rhenium alloy core;
providing at least one precursor of a coating material in a slurry;
depositing the slurry on the molybdenum-rhenium alloy core such that the molybdenum-rhenium alloy core is covered by the slurry; and
heating the molybdenum-rhenium alloy core covered by the slurry at a determined temperature in an inert atmosphere for a determined period of time to form a coating on the molybdenum-rhenium alloy core.

34. The method according to claim 32, wherein the metal elemental powder comprises at least one of aluminum, chromium, silicon, titanium, germanium, niobium, molybdenum, rhenium, iron, tin, and yttrium.

35. The method according to claim 32, wherein the coating material comprises at least one alloy precursor.

36. The method according to claim 32, wherein the metal precursor comprises at least one of aluminum, chromium, silicon, titanium, germanium, niobium, molybdenum, rhenium, iron, tin, and yttrium, combinations thereof, alloys thereof.
